(19) United States
(12) Patent Application Publication
(10) Pub. No.: US 2025/0314179 A1
(43) Pub. Date: Oct. 9, 2025

(54) Air-Water Thermal Power Plants

(71) Applicant: Yiding Cao, Miami, FL (US)

(72) Inventor: Yiding Cao, Miami, FL (US)

(21) Appl. No.: 18/863,091

(22) PCT Filed: Jun. 7, 2023
(86) PCT No.: PCT/US2023/024762

§ 371 Date: Nov. 5, 2024

Related U.S. Application Data
(60) Provisional application No. 63/353,606, filed on Jun. 19, 2022.

(51) Int. Cl. F01D 15/10; F01D 25/12; F01D 25/24

(52) U.S. Cl. CPC F01D 15/10; F01D 25/12; F01D 25/24; F05D 2220/76; F05D 2260/213

(57) ABSTRACT

This invention provides air-water thermal power plants that utilize hot water as a heat-supply fluid and operate at relatively low temperatures without combustion, yet are capable of producing utility-scale power with relatively high second-law efficiency. The air-water power plant uses both air and water as working fluids and incorporates a direct-contact mass and heat (or heat and mass) exchanger (or packing) to facilitate the transfer of latent heat (in the form of vapor) and sensible heat from hot water to a gaseous working fluid, which then expands in an expander to generate power. One of the further objectives of this invention is to recover heat and water from the working fluid exiting the expander through a regenerator condenser.

This application is a national stage application of the International Patent Applications: Air-Water Thermal Power Plants (PCT/US23/24762).

### FIELD OF INVENTION

This invention pertains to thermal power plants that utilize both air and water as working fluids, along with their associated energy storage systems. Specifically, this invention facilitates the use of renewable energy heat sources at relatively low temperatures to generate power and provide heat.

### BACKGROUND OF THE INVENTION

Thermal power plants capable of utilizing the vast thermal energy resources at low to medium temperatures to generate electricity on a utility scale could significantly advance renewable energy. Cao (2022a) demonstrated renewable-energy-based, utility-scale underground hot water storage facilities, which have the potential to displace most of global fossil fuel usage. However, the economic feasibility of these storage systems is highly sensitive to temperature and pressure, with a favorable temperature range near or slightly above 100° C., specifically between 90° C. to 150° C. Temperatures significantly above this range could exponentially increase the costs of the hot-water storage system. Additionally, heat acquisition by the water through solar collectors is more efficient at lower temperatures. As the temperature of the solar collector increases, its efficiency could decrease from approximately 75% to below 40%. For temperatures above 180° C., concentrating solar collectors may be required, which not only substantially increases the costs of solar acquisition but also fails to collect the diffuse component of solar irradiation, which typically constitutes 25% to 50% of the total solar flux.

Thermal power plants capable of generating power at lower temperature ranges are crucial for geothermal power production. According to the U.S. Department of Energy's Office of Energy Efficiency and Renewable Energy (EERE), geothermal energy resources below 300° F. (149° C.) represent the most common geothermal resource. A significant challenge in geothermal exploration is the substantial cost associated with drilling deep wells to access higher-temperature heat sources, often requiring drilling to depths of more than 5,500 meters depending on the project's geology. As the depth of geothermal drilling increases, the associated costs rise exponentially, potentially rendering the project economically infeasible.

Conventional steam turbine power plants require heat sources above 200° C. To address this limitation, binary-cycle/Organic Rankine Cycle (ORC) power systems were developed to operate at temperatures near 100° C. However, these systems use working fluids such as isobutane, pentane, and ammonia, or refrigerants like R-134a, R-123, or R245fa. These substances are hazardous, necessitating the complete sealing of the power system to prevent leakage. At approximately 100° C., their vapor pressure is very high, around 30 bars. Compared to water vapor expansion in expanders, their vapor expansion produces significantly less power. Consequently, ORC systems are typically limited to power capacities of about 10 KW with thermal efficiencies below 10%. While ORC systems may be acceptable for small-scale applications, their large-scale use poses significant health and environmental risks due to potential leaks under high pressure. Therefore, the adoption of ORC systems may be restricted.

Renewable power and heat are critical components of renewable energy strategies. Despite decades of development, renewable energies continue to play a supplementary role in global energy supplies, with over 80% of global energy consumption still derived from fossil fuels. To effectively combat global warming, it is predicted that major fossil fuels, such as coal, oil, and natural gas, must be replaced by renewable energies. Solar and wind power are the primary renewable energy sources under development due to their abundance, cost-effectiveness, and relatively limited environmental impact. However, their intermittent nature and seasonal variability limit their ability to fully replace fossil fuels. As a result, renewable power generation and heat supply using stored thermal energy become increasingly valuable for ensuring stable and reliable operation.

### SUMMARY OF THE INVENTION

Air and water are fundamental natural fluids on Earth, with their interactions, as well as their interactions with soil and other natural resources, sustaining life on the planet. Since the Industrial Revolution over 250 years ago, air and water have also served as the working fluids for power plants and engines. Water is utilized as the working fluid in steam engines and vapor power plants burning fossil fuels, as well as in nuclear power plants. Air serves as the working fluid in internal combustion (IC) engines, aircraft engines, and industrial gas turbine power plants.

Regarding core operational thermodynamic cycles, air is the exclusive working fluid in IC engines and gas-turbine-based power plants, with water being excluded. Conversely, water is the working fluid in steam engines and vapor power plants, with air being excluded. For instance, in a steam engine or vapor power plant, any significant accumulation of air is intolerable and must be removed via a vacuum pump system.

Philosophically, air and water may be seen as complementary fluids, akin to positive and negative electric charges. Their interaction is crucial for life and ecosystems on Earth, facilitating processes such as the water cycle in meteorology, which significantly impacts climate systems and ecosystems.

It is proposed that the interactions between air and water can also enable the development of a new power plant utilizing renewable energy sources, operating at sufficiently low temperatures to achieve utility-scale power production without the use of hazardous working fluids.

Therefore, it is a primary objective of this invention to provide air-water power plants that operate at relatively low temperatures without combustion, yet produce utility-scale power with relatively high second-law efficiency. The proposed air-water power plant utilizes both air and water as working fluids and employs a direct-contact mass and heat exchanger (or packing) to facilitate latent heat transfer (mass transfer in terms of vapor) in conjunction with sensible heat transfer from heat-carrying hot water to air. This process produces a mixture of vapor and air for expansion in an expander to generate power. The direct contact nature of the mass and heat transfer in the packing enables the use of hot water at a relatively low temperature as the heat source for power production.

Another objective of this invention is to recover both heat and water from the expanded vapor-air mixture exiting the expander through a regenerator condenser. Here, colder water from the packing is directed to the regenerator to engage the expanded vapor-air mixture, thereby recovering heat and water, increasing the thermal efficiency of the power plant, and reducing water loss.

A further objective of this invention is to employ a vacuum-pump compressor system to maintain the pressure at the expander exit below ambient pressure, thereby creating an expansion ratio of the vapor-air mixture in the expander and facilitating exhaust discharge.

Additionally, this invention aims to use a chiller to cool the power plant's intake airflow, the airflow before a compression system, or the airflow in a compressor intercooler. This cooling reduces the power consumption of the compression system and enables the power plant to operate efficiently at high ambient temperatures under low heat source temperature conditions.

### BRIEF DESCRIPTION OF THE DRAWINGS

FIG. 1 is a schematic vertical sectional view of an air-water power plant unit employing a frontal compressor system before a direct-contact mass-heat transfer packing for expansion in a turbine according to an embodiment of the subject invention;

FIG. 2 is a schematic, conceptual illustration of the flow patterns in a local area of the packing;

FIG. 3 is a schematic, sectional view of a water collector system shown in FIG. 1;

FIG. 4 is a flow diagram demonstrating the operation principle of the power plant as shown in FIG. 1, including a water or heat recovery unit for water or heat usage;

FIG. 5a is a thermodynamic cycle of the air-vapor mixture in terms of a t-s diagram with certain idealizations for the power plant in FIG. 1;

FIG. 5b is a thermodynamic cycle of the water associated with the operation of the power plant in FIG. 1 in terms of water temperature t_{w} vs. the ratio of water flow rate to dry air flow rate, r_{wa};

FIG. 6 is a schematic illustration of a chiller system to cool the intercooler air of a compressor system;

FIG. 7 is a schematic vertical sectional view of an air-water power plant employing a vacuum-pump compressor system to maintain turbine backpressure below the ambient pressure and discharge the exhaust air;

FIG. 8a is a flow diagram demonstrating the operation principle of the power plant as shown in FIG. 7;

FIG. 8b shows pressure distribution along with the height of the power plant as shown in FIG. 7;

FIG. 9 is a flow diagram of an air-water power plant with a separate flash chamber;

FIG. 10 is a flow diagram of an air-water power plant incorporating both frontal compression and a back vacuum-pump compressor system;

FIG. 11 is a flow diagram of an air-water power plant incorporating a reheat mechanism;

FIG. 12 is a flow diagram of an air-water power plant with vapor as the energy-supply fluid and the removal of the packing system; and

FIG. 13 is a schematic vertical sectional view of an air-water power plant unit employing an internal cooling mechanism such as water mist cooling for a compressor system;

### DETAILED DESCRIPTION OF THE INVENTION

In an air-water power plant of this disclosure, air or air-vapor mixture is an energy-receiving fluid while hot water is an energy-supplying fluid to enable power production through an expander such as a turbine. Said hot water may be preferably a liquid, but it could also be a liquid-vapor two-phase mixture or a superheated vapor. The energy acquisition by the working fluid may be in the form of latent heat in terms of the hot water evaporation and vapor addition into the air or air-vapor mixture flow in a direct-contact mass and heat exchanger or packing. Said vapor along with the dry air would then produce power in an expander such as a turbine. Due to the high latent heat of the vapor, on the order of 2200 kJ/kg, even if the sensible heat acquisition may be limited, the total energy acquisition may be high to produce enough power. Since the dry-air flow rate may be essentially a constant throughout the packing and turbine, the power production capacity of the turbine, as well as the amount of vapor content in the air-vapor mixture to the turbine, may be measured based on per kg of dry air. A parameter to measure the vapor content or the latent heat level in moist air or air-vapor mixture (or vapor-air mixture) is the humidity ratio (or specific humidity) W in kg of vapor mass per kg of dry air, and the related air-vapor mixture enthalpy at the inlet of a turbine, in kJ per kg of dry air, can be approximated by the following relation (McQuiston, 2005).

$${h}_{i} = {c}_{pa} \times t + W \times ( {h}_{fg} + {c}_{pv} \times t ) \qquad ( 1 )$$

wherein t is the temperature in degrees °C., cₚₐ is the specific heat of dry air, h_{fg} is the water latent heat of vaporization at 0° C., and cₚᵥ is the corresponding vapor-specific heat. It is well known that in a thermal power plant, the enthalpy of the working fluid at the inlet of a turbine may determine the power production capacity of the turbine under given turbine outlet conditions (Moran et al., 2011), as shown by Eq. (2) below, after the effects of the kinetic and potential energies, as well as the strayed heat from the turbine, are neglected:

$${w}_{t} = {h}_{i} - {h}_{o} \qquad ( 2 )$$

wherein wₜ is the work developed by the turbine, hᵢ is the enthalpy at the turbine inlet, and hₒ is the enthalpy at the turbine outlet. For the air-water power plant of this disclosure, for convenience, all three terms in Eq. (2) would have a unit of kJ/kg dry air. The inlet enthalpy from Eq. (1) would represent the total energy content of the air-vapor mixture which subsequently determines the power production capacity of the power plant. It is clear from Eq. (1) that the total enthalpy is largely determined by the humidity ratio W, as the first term on the right side of Eq. (1), which represents the sensible heat of dry air, is rather small for low-temperature power plants. In contrast, for a conventional fossil-fuel-based gas turbine power plant, the second term on the right side of Eq. (1) is essentially close to zero, and the sensible heat represented by the first term is the contributor to the turbine-inlet enthalpy. In this case, the temperature in the first term often may need to be more than 1500° C. through the combustion of fossil fuels to attain sufficient sensible heat for high turbine power production.

Referring to Eq. (1), the saturated humidity ratio under given thermodynamics conditions would represent the maximum amount of vapor that the air-vapor mixture could accommodate, which would then determine the maximum thermal energy content of the mixture at the turbine inlet as well as the maximum power capacity of the turbine under given turbine inlet temperature and outlet conditions. Since the mixture temperature at the turbine inlet may be close to the temperature of the hot water entering the power plant, the saturated humidity ratio at the turbine inlet may also represent the power plant potential at a given heat source temperature. The following relation can be used to calculate the saturated humidity ratio (McQuiston, 2005; Moran et al., 2011) with sufficiently high accuracy:

$${W}_{s} = 0.622 \frac{{p}_{s} ( t )}{( P - {p}_{s} ( t ) )} \qquad ( 3 )$$

wherein pₛ is the saturation vapor pressure corresponding to the temperature of the air-vapor mixture and P is the total or system pressure of the mixture. Table 1 shows the saturated humidity ratio, the latent heat content, sensible heat content, and the latent heat share under some air-water mixture conditions in terms of temperature and total pressure, wherein the latent heat content is defined as the thermal energy associated with the vapor component.

TABLE 1
Latent heat potential of the air-vapor mixture
at some given temperature and total pressure

| | | | | Latent | Sensible | |
|---|---|---|---|---|---|---|
| | | | Wₛ | heat | heat | Latent |
| | pₛ | P | (vapor/ | (kJ/kg | (kJ/kg | heat |
| t (° C.) | (bar) | (bar) | dry air) | dry air) | dry air) | share (%) |
| 126 | 2.383 | 3.03 | 2.290 | 6305.1 | 126.0 | 98.0 |
| 116.2 | 1.753 | 2.53 | 1.412 | 3881.9 | 116.2 | 97.1 |
| 106.3 | 1.267 | 2.02 | 1.045 | 2822.5 | 106.3 | 96.4 |
| 96.6 | 0.896 | 1.01 | 4.91 | 13176.1 | 96.6 | 99.3 |
| 86.9 | 0.621 | 1.52 | 0.432 | 1155.6 | 86.9 | 93.0 |
| 40 (for | 0.0738 | 1.01 | 0.0491 | 126.7 | 40 | 76.0 |
| cooling tower | | | | | | |
| applications) | | | | | | |

As can be seen from Table 1, as temperature increases from 86.9° C. to 126° C., the latent heat content of the air-vapor mixture increases exponentially. At a temperature of 116.2° C., the latent heat component in the mixture is more than 97% with negligible sensible heat contribution. The results in the table also show that although the operating temperature has a dominant effect on the saturation humidity ratio, a lower system pressure or total pressure may significantly improve the humidity ratio. For example, at a temperature of 96.6° C. and a total pressure of 1.01 bar, the saturation humidity ratio has a value of about 4.89, much higher than that at a higher temperature of 126° C. and a higher total pressure of 3.03 bar. Table 1 also shows a case of a cooling tower application with an up-end temperature of 40° C. In cooling tower applications, the sole objective is to cool the water down to close to the ambient temperature through water evaporation into the air, and the air conditions in the tower are not an interest of the operation. Still, even though the magnitude of the latent heat component in the moist air is rather small due to the low temperature, its share in the total energy content of the moist air is more than 75%.

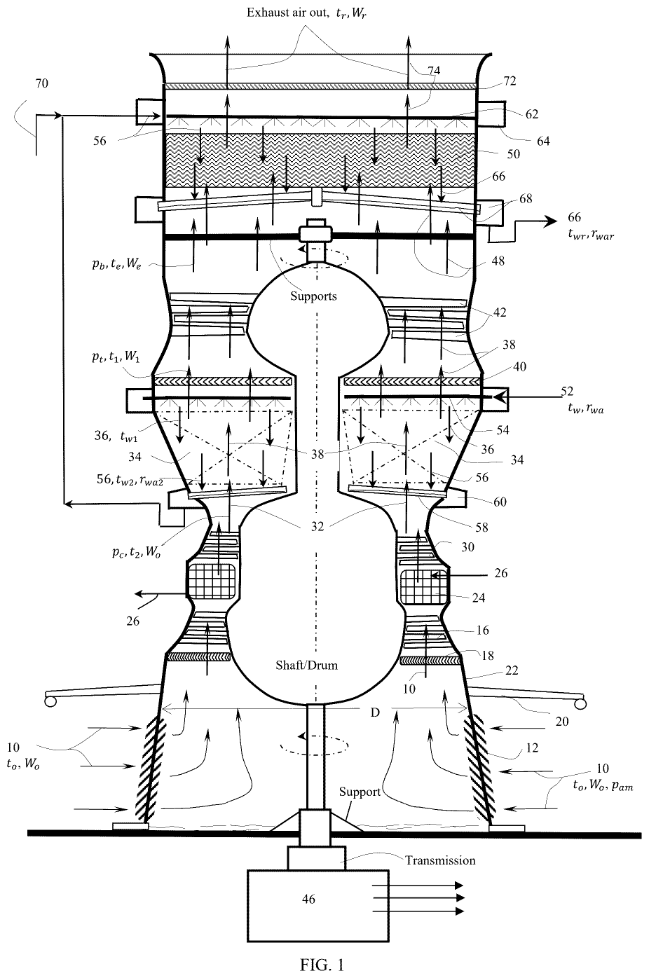

Because of the advantageous open-cycle, simpler structure, and quick startup of the gas turbine cycle over the closed-cycle of vapor power plants, a gas turbine power platform is adopted for the first embodiment of the air-water power plant. FIG. 1 illustrates schematically an air-water power plant unit in terms of an axial turbine or compressor of a generally circular cross-section using hot water as an energy-supply fluid. Referring to FIG. 1 and starting from the bottom of the power plant, ambient moist air 10 at tₒ and Wₒ as well as pressure pₐₘ is induced into the power plant through an air inlet section with louvers 12. Air 10 converges and flows upward to the inlet of a first compressor 16 of a compressor system. A drift eliminator 18 may be installed before the inlet of the compressor to prevent liquid or solid particles from entering the compressor. Inlet roofing 20 may be disposed around casing 22 of the power plant, as shown in the figure, for a similar purpose, particularly for storming or snowing weather conditions. If the combined functions of inlet roofing and louvers are sufficiently effective to prevent liquid or solid particles from entering the compressor, the drift eliminator 18 at the inlet of the compressor may not be necessary.

The airstream 10 enters the first compressor 16 of the compressor system, which may include two compressors and an intercooler 24, and is compressed to a higher pressure and higher temperature. Then the air flows through an intercooler 24 and it may be cooled back to near its inlet temperature to the first compressor 16. As shown in FIG. 1, cooling water 26 enters the intercooler through an upper section and exits the intercooler through a lower section. Because of the preferred low-temperature operational characteristics of the air-water power plant, it is essential to adequately cool the air through the intercooler and maintain a lower temperature at the outlet of the compressor system. The intercooler would also reduce the compressor power consumption and increase the energy recovery from a regenerator which will be described later in this disclosure. The intercooler could be any suitable type of heat exchanger including counterflow and crossflow types, but a particular type of microchannel heat exchanger may have the advantage for the present application for air temperature reduction and lower pressure drop across the intercooler. Alternatively, a direct-contact heat exchanger may be used as the intercooler (not shown). The cooled air continues its flow path after the intercooler and enters a second compressor 30. The compressed air stream 32 with a further increased pressure leaves the second compressor 30 with p_{c}, t₂, Wₒ, as shown on the left side of the figure. Although FIG. 1 shows only one intercooler and two compressors, more than one intercooler, and more than two compressors may be installed (not shown)

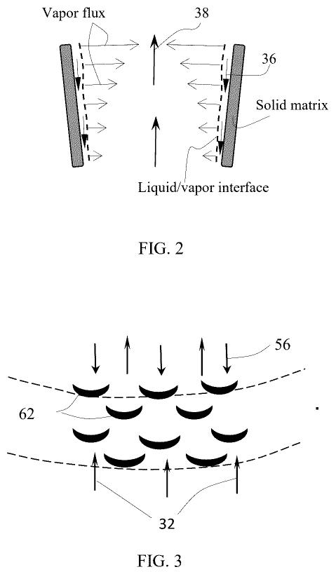

Upon leaving the compressor system, the compressed air 32 enters a packing 34 to acquire latent and sensible heat from counterflowing hot water 36 to raise its vapor content and temperature and may essentially become a vapor-air mixture 38. The packing, fill, or packed bed herein is a direct-contact heat and mass exchanger between hot water and air-vapor mixture. In this disclosure, moist air and air-vapor (or vapor-air) mixture are interchangeably used. However, the term moist air may signify that the vapor content in the air is relatively small, while the air-vapor or vapor-air mixture may signify that the vapor content in the mixture is significant. Through the intimate contact between the down-flowing hot water 36 and the up-flowing colder air-vapor mixture 38, combined mass and heat transfer takes place from the hot water to the air-vapor mixture at the interfaces between the hot water and air-vapor mixture. Hot water vaporizes at the interface and enters the air-vapor mixture stream due to higher vapor pressure at the interface than the partial vapor pressure in the air-vapor mixture. The packing is essentially a system of baffles to slow down the progress of the hot water and maximize the contact between the hot water and the air-vapor mixture (Hill et al., 1990). It also increases the contact surface area between the hot water films and the air-vapor mixture as well as minimizes the thickness of hot water films Another packing design objective is to minimize the pressure drop of the air-vapor mixture across the packing. FIG. 2 is a conceptual illustration of flow patterns in a local area in the packing, wherein the upward air-vapor mixture flow 38, the downward hot water film flow 36, vapor mass flux from the interface between the liquid and air-vapor mixture to the air-vapor mixture, and the solid matrix of the packing are schematically shown. However, the sensible heat transfer from the liquid film to the air-vapor mixture is not shown, which raises the temperature of the air-vapor mixture from the bottom to the top of the packing. It should be emphasized that the conceptual illustration may not reflect the real configuration of the flow passages and packing solid matrix, which could be characterized as complex, tortuous, and random to benefit the intensity of the mass and heat transfer.

Packings and their theories and applications for cooling towers have been described in detail by Hill et al. (1990), Hewitt et al. (1994), and others. The packing for the air-water power plant of this disclosure may have a similar configuration found in cooling towers for power and air conditioning systems but with a different objective. In the cooling tower applications, the objective of using a packing is to cool a water flow as low as possible to be used as the condenser coolant of a power plant or a chiller for an air conditioning (A/C) application (McQuiston, 2005 and Moran et al., 2011), while the thermal conditions of the moist air that is discharged into the ambient is not an interest. On the other hand, the objective of the present application through the packing is to increase the energy content of the air-vapor mixture through the increase of its vapor contents and temperature, so that the energy contents of the mixture can be used to generate power through a turbine or other expanders.

Referring to FIG. 1 again, after the energy acquisition in packing 34, the air-vapor mixture 38 exits packing 34 with increased humidity ratio and temperature, W₁ and t₁, as shown on the left side of the figure. Upon passing through a drift eliminator 40 to remove liquid droplets, the air-vapor mixture 38 is ducted into a turbine 42 to produce power through expansion. In the illustration in FIG. 1, the turbine, compressors, and electric generator may be linked through a shaft/drum. A portion of the power generated by turbine 42 is used to drive the compressor system (16 and 30) and the remaining power may be used to generate electricity through an electric generator 46, as shown near the bottom of FIG. 1. A starter and other necessary systems may also be installed but are not shown in the figure. After the expansion and converting some of the thermal energy content into power, the air-vapor mixture 48 exits the turbine with reduced pressure p_{b}, temperature tₑ, and humidity ratio Wₑ, wherein p_{b} is the turbine outlet pressure or backpressure, as shown in FIG. 1. But the air-vapor mixture exiting the turbine may still contain a large amount of unused thermal energy and water, particularly in terms of vapor content in the mixture, and direct discharge into the ambient would seriously affect the thermal efficiency of the power plant and cause significant water loss. Therefore, a regenerator condenser 50 is employed to recover a significant amount of the energy and water from the mixture, and the air-vapor mixture 48 would continue its flow path to enter the regenerator 50. However, before completing the description of the air-vapor mixture process, let's switch the attention to the hot water as the energy-supply fluid of the power plant unit.

Referring to packing 34 in the middle section of FIG. 1, hot water 52, as a heat-supply fluid, at a temperature t_{w}, enters the power plant through a hot water distribution system 54 on top of the packing. The hot water 52 may be delivered from an energy storage system or directly from a heat source. Said heat source may be but is not limited to, solar energy, geothermal energy, industrial waste heat, biomass, or fossil-fuel-related thermal energies through combustion or nuclear reactions. Since the dry air mass may be a constant from the inlet to the outlet of the power plant, like the cooling tower, the power plant analysis herein is based on the unit mass of the dry air. Therefore, the mass flow of the hot water at the inlet of the power plant is measured in kg of water per kg of dry air, r_{wa}=\dot{m}_{w}/\dot{m}ₐᵢᵣ, as shown in the figure, where \dot{m}_{w} is the mass flow rate of hot water and \dot{m}ₐᵢᵣ is the mass flow rate of dry air. Because some liquid may flash into vapor through the hot water distribution system 54, the actual temperature of the hot water 36 entering the packing 34 from the top would be t_{w1}, as shown on the left side of the power plant. The corresponding mass flow rate would be r_{wa1}=\dot{m}_{w1}/\dot{m}ₐᵢᵣ, although sometimes the flow rate entering the power plant is also marked as r_{wa1}. Through the mass and heat transfer as well as counterflow arrangement, the hot water 36 may impart a significant amount of its thermal energy to the air-vapor mixture, accompanied by a significant reduction in the water temperature. The water 56, with a reduced temperature of t_{w2} and a lower water mass flow rate of r_{wa2}, exits packing 34 at the packing bottom. Notice that r_{wa2} is less than r_{wa1} because in the packing some of the water has been vaporized and the generated vapor has joined the up-flowing air-vapor mixture.

The colder water 56 out of the packing is collected by a collector system 58 comprising arrays of longitudinal collectors that may have a pan or bow-shaped cross-section and a peripheral water tank 60. The collector system 58 would extend radially and would incline downwardly from the power plant central region to the plant casing, so the gravitational force is unitized to drive the water to the peripheral water tank 60. A sectional view of the collector arrangement is schematically shown in FIG. 3. Referring to FIG. 3, a plurality of circumferential rows of collector elements 62 of a pan or bow-shaped cross-section is staggered in the direction of the water flow 56 to capture and collect the water out of the packing. The width of the collector elements may also increase radially because of the increased circumference with increased radius. The arrangement of the collector elements 62 would also aim to reduce the pressure loss of the moist air 32 across the collector arrays to enter packing 34.

As mentioned earlier in this disclosure, the water 56 exiting packing 34 and being collected by collector system 58 may have a significantly reduced temperature and associated energy content because of the mass and heat transfer in the packing. The water could be directly pumped from the peripheral water tank 60 to a storage system to be heat-recharged or directly sent to a heat source, such as solar collectors or other heat sources, for thermal recharging. However, if the water is pumped from the water tank 60 to the regenerator 50 to recover a significant amount of energy and water from the air-vapor mixture 48 exiting the turbine 42, a lot of energy and water could be saved.

The regenerator 50, as shown near the top of the power plant in FIG. 1, may be a counter-flow, direct-contact condenser with a packed bed or packing, wherein the colder water 56 exiting the packing 34 may be pumped from the water tank 60 to a water distribution system 62 on top of the regenerator 50 through a peripheral water tank 64. The packed bed 50 creates intimate contact between the colder, down-flowing water and up-flowing hotter air-vapor mixture 48 exiting the turbine and entering the regenerator 50 from the bottom of the bed, which effectively condenses vapor in the air-vapor mixture 48 and heats the water through the condensation released heat. The condensate would join the downflowing water flow stream and increase the water mass flow rate from the top to the bottom of the regenerator.

Compared to a non-direct contact condenser with walls separating the vapor from cooling water flow, the direct contact condenser with the bed could have hugely increased condensation efficiency because of the drastically increased condensation surface area between the vapor and cooling water and minimized thermal resistance between the direct contacting vapor and cooling water. The direct-contact condenser could condense nearly all the vapor with limited bed height, and the final temperature of the water would depend on the energy balance between the inlet vapor flow conditions and the inlet water flow condition (Hewitt et al., 1994). The exiting temperature of the water at the bottom of the regenerator 50 could be close to the inlet vapor temperature when the total inlet vapor-flow energy content is higher than the maximum energy acquisition potential of the inlet water flow.

Referring to regenerator 50 again, after recovering a substantial amount of energy and water from the air-vapor mixture through the regenerator, water 66, with an increased temperature of t_{wr} and a mass flow rate of r_{war}, exits the regenerator 50 and is collected by a water collection system 68, similar to 58 for packing 34. The collected water 66 may be pumped from the water collection system 68 to a storage facility (not shown) or directly to a heat source to be thermally recharged (not shown). Said heat sources may be but are not limited to, solar energy, geothermal energy, industrial waste heat, biomass, or fossil-fuel-related thermal energies through combustion or nuclear reactions. The water flow rate out of the regenerator 50 may not be the same as that of the hot water 52 at the inlet of the water distribution system 54 for packing 34 before the turbine. However, some makeup water 70 may be added to the top of the regenerator, as shown in FIG. 1 near the top of the power plant. As a result, the water flow rate per kg of dry air out of the power plant, r_{war}, may approach r_{wa}, the hot water flow rate entering the power plant, for power cycle considerations.

On the air-vapor mixture side, the mixture enters the regenerator 50 from the bottom of the regenerator condenser with tₑ, Wₑ, and leaves the regenerator with significantly reduced temperature and vapor content, tᵣ, Wᵣ. After passing through a drift eliminator 72, the air-vapor flow stream 74 out of the regenerator is discharged into the ambient as exhaust. It should be pointed out that for simplicity of illustration, the effect of the drift eliminator on the thermal condition of the air-vapor mixture is not considered. However, the exhaust may still contain a significant amount of water vapor and heat, and a water or heat recovery unit may be added to recover as much water or heat as possible before the exhaust airflow stream is discharged into the ambient. The water or heat recovery is not included in FIG. 1 because of its emphasis on power production, but it will be discussed in the following of this disclosure.

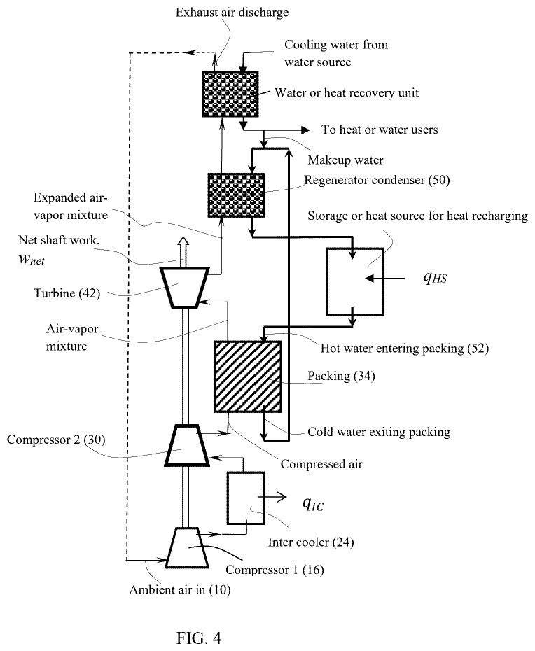

To further illustrate the air-water power plant as shown in FIG. 1, a flow diagram demonstrating the operational principle of the power plant is shown in FIG. 4, wherein a water or heat recovery unit is added after the regenerator condenser. The water or heat recovery opens the door for the dual use of power and heat, as the recovered water and heat may be delivered for various uses, such as, but not limited to, domestic hot water, home heating, and industrial uses. In many cases, an open-cycle power plant may be preferred. However, this does not exclude the operation of a closed-cycle power plant. Additionally, thermodynamics cycle analyses are often based on the concept of a closed cycle even if the real operation is based on the open cycle. For these reasons, the operation as shown in FIG. 4 may be treated as a closed cycle. As shown by the dashed lines, after further removing some moisture and reducing its temperature, the exhaust flow may return to the inlet of the compressor system and is treated as the ambient air for closed-cycle analysis. It should also be mentioned that in many real situations, the water or heat recovery unit in FIG. 4 may be combined with the regenerator condenser.

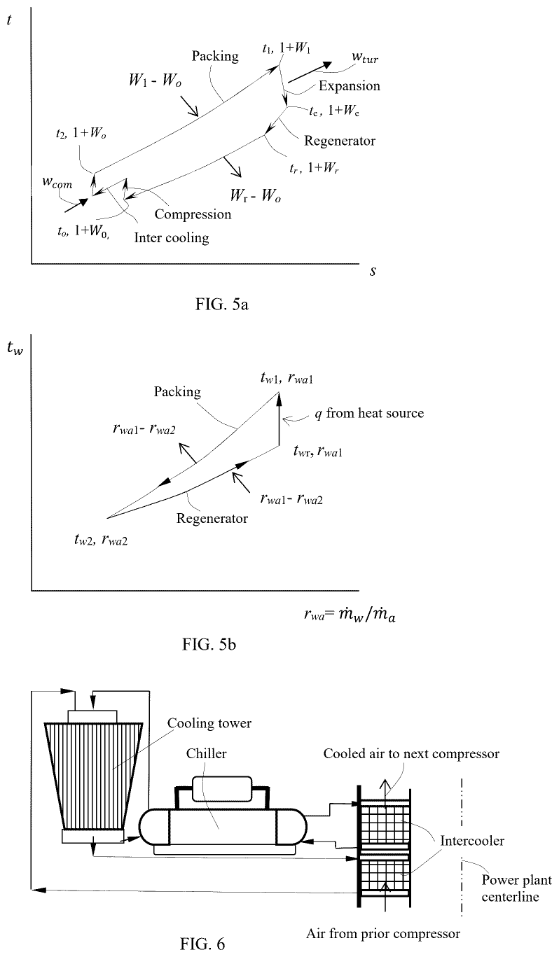

In the air-water power plant, both air and water are core components of the working fluid, and for this reason, the thermodynamic cycles for both the air-vapor mixture and hot water are used to illustrate the working principle of the power plant. FIG. 5a shows a thermodynamic cycle for the air-vapor mixture in terms of a temperature-entropy (t-s) diagram with certain idealizations. As mentioned before, the dry-air mass flow rate through the power plant is normally unchanged, and the cycle would be conveniently illustrated based on the mass of the air-vapor mixture per kg of dry air. At the inlet of the compressor system which may include at least one intercooler, the temperature of the ambient moist air is tₒ, the mass of the vapor in the ambient air is Wₒ (the humidity ratio), and the pressure is pₐₘ. The ambient air mass on the basis of per dry air would be 1+Wₒ. The moist air is compressed by the compressor system to a higher pressure p_{c} with the input of an amount of mechanical work, w_{com}. The compressed moist air leaves the compressor system at t₂ and 1+Wₒ, and enters a direct-contact packing (heat and mass exchanger), wherein the moist air simultaneously receives both vapor and heat from a hot-water flow stream. The air-vapor mixture leaves the packing with an increased temperature and humidity ratio, t₁, W₁, along with the pressure of pₜ that may be close to p_{c} as the pressure drop through the packing is generally small. Vapor addition to the air-vapor mixture on the basis of 1 kg of dry air would be W₁−Wₒ, as marked in FIG. 5a. The air-vapor mixture then enters a turbine or another type of expander to develop an amount of shaft work, wₜᵤᵣ, and leaves the turbine with the condition of reduced temperature and pressure, represented by tₑ, p_{b}. The vapor content represented by _{We} may also be lower than W₁ due to some vapor condensation through the expansion in the turbine. The air-vapor mixture further reduces its energy content in a condenser regenerator, wherein its vapor content is also significantly reduced through vapor mass condensation and heat transfer to the colder water entering the regenerator from the exit of the packing. At the outlet of the regenerator, the air-vapor mixture has a reduced vapor content of Wᵣ along with a reduced temperature of tᵣ. In real situations, the air-vapor power plant may be an open-cycle system, and at this point, the exhaust air-vapor mixture out of the regenerator is discharged into the ambient. However, like many other thermodynamic cycle analyses, it may be modeled as a closed-cycle system herein. Therefore, a constant pressure process with further vapor mass and heat removal is added, and the moist air returns to its starting point of the cycle to complete the cycle. During this process, an amount of vapor mass, Wᵣ−Wₒ, as marked in the t-s diagram in FIG. 5a, left the moist air and entered the ambient air. It should be pointed out that possible water recovery between Wᵣ and Wₒ could be added, as shown in FIG. 4 so that most of the vapor water leaving the regenerator could be recovered without being lost to the ambient.

FIG. 5b shows a thermodynamic cycle of the water associated with the operation of the power plant in terms of a t_{w} vs. r_{wa} (water temperature vs. dimensionless water flow rate) diagram with certain idealizations, wherein r_{wa} is the ratio of the water flow rate \dot{m}_{w} to the dry air mass flow rate \dot{m}ₐ. It should be noted that t_{w} and r_{wa} herein are respectively used for generally varying water temperature and flow rate, not necessarily the temperature and flow rate of the hot water entering the power plant as shown in FIG. 1, which are also labeled respectively as t_{w} and r_{wa}. The hot water from a hot-water storage facility or a heat source enters the direct-contact heat-mass transfer packing at a temperature t_{w1} and a mass flow rate of r_{wa1}. It should also be mentioned that t_{w1} and r_{wa1} would respectively approach the temperature and flow rate of the hot water entering the power plant if the flash process in the water distribution system is neglected. After the mass and heat transfer from the hot water into the air-vapor mixture in the packing, the water leaves the packing with reduced temperature and mass flow rate, respectively at t_{w2} and r_{wa2}. The mass removal from the water in the packing, r_{wa1}−r_{wa2}, is marked in the packing process in FIG. 5b. Then the colder water enters the condenser regenerator, wherein the vapor in the hotter air-vapor mixture condenses, releasing its condensation heat. The water receives the released condensation heat and raises its temperature to t_{wr}, which may be close to tₑ in FIG. 5a. At the same time, water receives the condensate mass associated with the vapor condensation and increases its mass flow rate to r_{war}. Therefore, at the outlet of the regenerator, the water has an increased temperature and mass flow rate, and through makeup water addition, the water would regain its original mass of r_{wa1}, r_{war}=r_{wa1}. Obviously, this is an ideal condition for a better description of the cycle. The mass addition to the water in the regenerator, r_{wa1}−r_{wa2}, is also marked in FIG. 5b. The water leaving the regenerator is then thermally recharged by a heat source and its temperature is raised back to t_{wa1} to return to the packing and complete the cycle.

It is well known that for conventional closed-loop vapor power plants including nuclear power plants, a large amount of external cooling water is needed to condense the vapor in the condenser. Another significant advantage of the air-water power plant of this invention is the use of colder water out of the packing, such as 56 in FIG. 1, to condense vapor in the regenerator condenser to recover both heat and water, so that the need for additional cooling water may be substantially reduced.

In the embodiment shown in FIG. 1 as well as the cycle analyses, liquid hot water, such as 52 in FIG. 1, is primarily employed as the power-plant heat-supply fluid. However, a superheated vapor or liquid-vapor two-phase mixture may also be employed as the heat-supply fluid to the power plant. In the case of a liquid-vapor two-phase mixture, the vapor in the mixture entering the power plant may bypass packing 34 in FIG. 1 and flow directly to the turbine (not shown), while the liquid in the mixture would enter packing 34.

The potential performance of air-water power plants as disclosed above was evaluated through model calculations, and some of the key results are summarized in Table 2 (Cao, 2022b), although the detail of the modeling is not included in this disclosure. For all of the results in the table, the ambient temperature was set at tₒ=15° C., and the isentropic efficiencies for compressor and turbine systems were set, respectively, at 90% and 95%.

TABLE 2
Performance results for the power plant shown
in FIG. 1 at tₒ = 15° C.

| | | wₙₑₜ | Power | Thermal | Second-law |
|---|---|---|---|---|---|
| t_{w} | Compression | (kJ/kg | capacity | efficiency | efficiency |
| (° C.) | ratio | dry air) | (MW) | (%) | (%) |
| 130 | 2.85 | 497.8 | 171.7 | 15.37 | 53.9 |
| 120 | 2.25 | 272.3 | 93.9 | 14.9 | 55.8 |
| 110 | 1.583 | 165.9 | 57.2 | 13.6 | 54.8 |
| 100 | 1.5 | 58.6 | 20.2 | 12.51 | 54.9 |
| 90 | 1.75 | 30.84 | 10.6 | 10.9 | 52.66 |

The above results were based on the hot water inlet temperature, t_{w}, to the power plant and the compression ratio of the compressor system. The plant diameter D shown in FIG. 1 was set at 6 m and the dry air velocity at the location where the D is measured was 10 m/s. The results were also associated with the use of two intercoolers in the compressor system.

The second-law efficiency is defined as the ratio of the thermal efficiency listed in the above table to the corresponding Carnot cycle efficiency. The results above indicated that at an inlet hot water temperature above 120° C., the power capacity of the air-water power plant may reach the level of 100 MW, competitive with the conventional fossil fuel-based power plant. Thermal efficiency could also approach or reach 15%, which is rather high under the condition of low-temperature operations.

The performance results show that the temperature of the hot water entering the power plant as the heat-supply fluid is a determining factor. As t_{w} shown in FIG. 1 is increased, both power output and thermal efficiency improve significantly. However, these improvements are not without penalties. Because of the increased saturation pressure at a higher temperature, the compression ratio may have to be accordingly increased for an increased operational pressure of the air-vapor mixture. Higher pressure may make the compressor and turbine system more costly and limit the size of the power plant, such as diameter D, which in turn would limit the power capacity. To avoid higher pressure, a flash mechanism of water may be employed. For example, if the hot water inlet temperature is around t_{w}=150° C., which has a corresponding saturation pressure of about 4.80 bar. If the packing operational pressure is set at around 3.0 bar, the pressure of the hot water entering the packing could be reduced from about 5 bar to about 3.0 bar at the exit of the spray nozzles of the water distribution system 54, accompanied by a flash process, in which an amount of the water entering the distribution system 54 would be flashed into vapor at a reduced temperature of around t_{w1}=134.0° C. The vapor generated through the flash process would flow to the turbine as well as mix with the air-vapor mixture out of the packing, while the remaining liquid water after flashing would enter the packing from its top. In this case, the performance of the power plant may not reach the potential associated with 150° C., but the power capacity may be significantly increased compared to the case if the hot water inlet temperature to the power plant unit were 130° C.

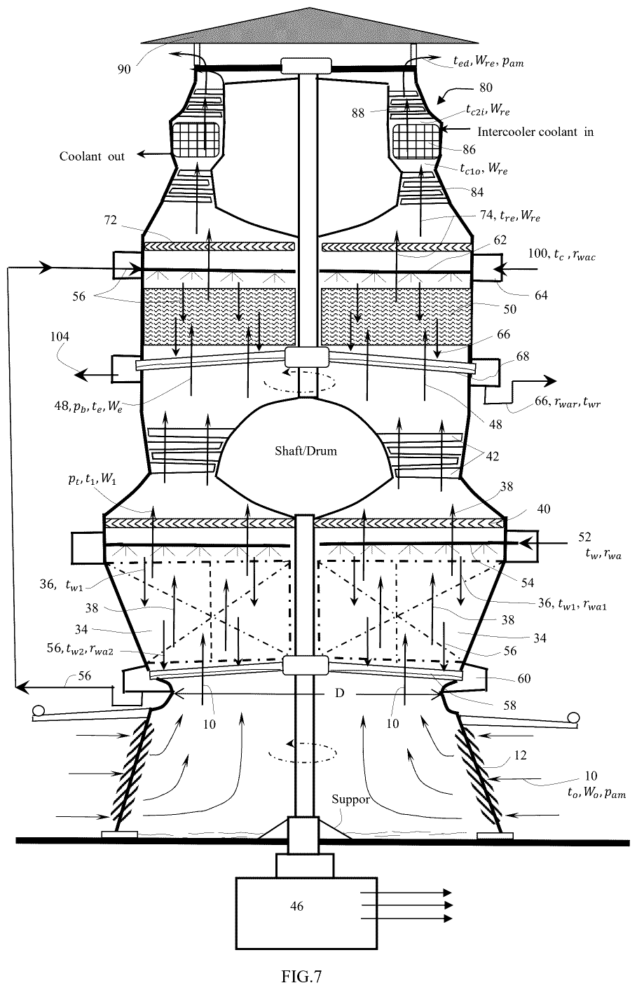

In the above calculation results, the ambient air is set at 15° C. which is the standard temperature for thermal power plant evaluations in the industry. This temperature may be reasonable for the winter or year-round average; but in the summer, the average ambient temperature should be much higher than that. The power plant performance may be significantly affected by a higher ambient temperature even for some conventional steam-turbine-based fossil fuel power plants. However, the impact of the higher ambient temperature will be much more severe for the present air-water power plants under low operating temperatures. To alleviate this problem, a technique to use a chiller to cool the intake air of the power plant, the inlet air of a compressor system, or the intercooler air below the ambient temperature may be employed. FIG. 6 shows schematically the cooling of intercooler air by a chiller. To quantitatively demonstrate the effectiveness of this technique, the results in Table 2 are used as a base for comparison. In this case, a centrifugal chiller was used to cool the second intercooler air after the ambient temperature and relative humidity were increased, respectively, to t₀=35° C. and Wₒ=0.018 vapor/dry air, which may represent weather conditions for summer. Like other refrigeration systems, the chiller's performance is gauged by its coefficient of performance (COP) as defined by the following relation.

$$COP = \frac{Heat removal}{work input} \qquad ( 4 )$$

To reduce the power consumption of the chiller, the intercooler as shown in FIG. 6 was divided into two sections. The lower section is cooled by the water from a cooling tower of the chiller to reduce the air temperature to near the ambient temperature of 35° C. before the air is directed to the upper section of the intercooler. It should be mentioned that the cooling tower in FIG. 6 may be replaced by a dry-cooling system for water conservation. For comparison purposes, in the second section of the intercooler, the chiller would cool the air to the condition of t₀=15° C. and Wₒ=0.005 vapor/dry air, which is the ambient condition used for the results in Table 2, before the air is directed to the next compressor.

In the case of t_{w}=120° C. and a compression ratio of 2.25 under the ambient air condition of t₀=35° C. and Wₒ=0.018 vapor/dry air with the incorporation of the chiller cooling on the second intercooler, computer program calculation was undertaken and the results for the network output and thermal efficiency are respectively given below:

$${w}_{net} = 263.4 kJ / kg - dry air , {η}_{th} = 14.11 \% .$$

However, the net workout above must be corrected due to the work consumption of the chiller to achieve the cooling effect. The centrifugal chiller generally has a much higher coefficient of performance (COP) than a residential air conditioning system, and a COP of 8 to 9 is not uncommon (HVAC HESS; Evans 2017; and DAIKIN, 2020). The chiller work consumption can be calculated by the following relation on the basis per kg of dry air by using a chiller COP of 8:

$${w}_{chiller} = \frac{Δ h}{COP} = \frac{20.27}{8} = 2.53 \frac{kJ}{kg dry air}$$

where Δh is the enthalpy drop between the condition of t₀=35° C., Wₒ=0.018 to the condition of t₀=15° C., Wₒ=0.005. Then, the corrected network and thermal efficiency are respectively shown below:

$${w}_{net , c} = 263.4 - 2.53 = 260.87 \frac{kJ}{kg dry air}$$

$${η}_{th , c} = 14.11 \times \frac{260.87}{263.4} = 13.97$$

Compared to the result shown in Table 2 with the ambient condition of tₒ=15° C., Wₒ=0.005 without chiller cooling, the new work output, and thermal efficiency decreased, respectively, by about 4.5% and 6%.

In the case of t_{w}=100° C. and a compression ratio of 1.5 under the air inlet condition of tₒ=35° C., Wₒ=0.018, calculations were also done under similar chiller cooling procedures, and results are summarized in Table 3 along with the results of t_{w}=120° C.

TABLE 3
Results for ambient conditions of t₀ = 35°
C., Wₒ = 0.018, with chiller intercooler cooling, as compared
to the results of t₀ = 15° C., Wₒ = 0.005 from Table 2.

| | | Network (kJ/kg | | Thermal efficiency | |
|---|---|---|---|---|---|
| | | dry air) (Change | | (%) (Change over | |
| t_{w} (° C.) | Compression | over the case of | | the case of | |
| (t₀ = 35° C.) | ratio | t₀ = 15° C.) | | t₀ = 15° C.) | |
| 120 | 2.25 | 260.87 | (−4.5%) | 13.97 | (−6%) |
| 100 | 1.5 | 52.51 | (−10.3%) | 10.3 | (−11.2%) |

The results in Table 3 show that when the chiller cooling technique is employed, an increase from the ambient temperature of 15° C. to the ambient temperature of 35° C. only reduces network output by 4.5% and thermal efficiency by 6% for the case of 120° C. of hot water inlet temperature. For the case of 100° C., the reduction in network and thermal efficiency are respectively 10.3% and 11.2%. The negative impact is higher at 100° C., but its thermal efficiency is still above 10%.

The chiller employed in the above disclosure is based on the mechanical-energy-driven chiller type. However, other types of chillers may also be employed, including, but not limited to, absorption-type chillers that may be driven by a heat source, said heat source may be the hot water from a hot water storage system.

According to the performance results in Table 2 as associated with the power plant embodiment in FIG. 1, when t_{w} is equal to or below 100° C., power output drops sharply accompanied by a significant reduction in thermal efficiency. Also, the air-vapor mixture is unable to expand through the turbine to an outlet or back pressure lower than the ambient pressure, as is the case for most conventional steam turbine power plants.

FIG. 7 shows schematically another embodiment of the air-water power plant unit of this invention, which would significantly improve the performance of the power plant with the entering hot water temperature equal to or below 100° C. In this case, a vacuum pump or compressor system is installed after the regenerator condenser to create a turbine outlet or back pressure lower than the ambient pressure and also to discharge the exhaust air and vapor out of the power plant unit. Referring to FIG. 7 and starting from the bottom of the power plant, ambient moist air 10 at tₒ and Wₒ is induced into the power plant through an air inlet section with louvers 12. A fan may be installed for air intake purposes (not shown), but this sometimes may not be necessary. The air 10 converges and flows upward into packing 34 from the bottom to acquire latent and sensible heat from the counterflowing hot-water flow stream. Similar to the packing in FIG. 1, it has an associated hot water distribution system 54, a colder water collector system 58, and a peripheral water tank 60. The packing, hot water distribution system, the colder water collector system, and peripheral water tank have been described as associated with FIG. 1 and their descriptions will not be repeated herein. Hot water 52, as the energy-supply fluid of the power plant with a temperature t_{w} and mass flow rate of r_{wa}, based on the unit mass of the dry air, enters the power plant through the hot water distribution system 54. The hot water, leaving the distribution system and entering the packing from the top at a temperature of t_{w1}, is designated by 36. If the hot water flashing through the distribution system is neglected, t_{w1} may approach t_{w} with the same water flow rate. Through the intimate heat and mass transfer in the packing from the hot water 36 to the airflow stream 10, the moist air 10 may essentially become an air-vapor mixture, as designated by 38, due to the significantly increased vapor content.

After the energy acquisition in packing 34, the air-vapor mixture 38 exits the packing with an increased humidity ratio W₁ and an increased temperature t₁, but its pressure pₜ may be close to the ambient pressure pₐₘ as the pressure drop through the packing may be generally small, as shown on the left side of FIG. 7. Upon passing through a drift eliminator 40 to remove liquid droplets, the air-vapor mixture 38 is ducted into a turbine 42 to produce power through expansion from pₜ to turbine outlet or back pressure that may be significantly lower than the ambient pressure. After the expansion and converting some of the thermal energy content into power, the air-vapor mixture 48 exits the turbine with reduced pressure p_{b}, temperature tₑ, and humidity ratio Wₑ, wherein p_{b} is the turbine back pressure, as shown in FIG. 7. However, the air-vapor mixture exiting the turbine still contains a large amount of unused thermal energy, particularly in terms of vapor content in the mixture. Therefore, a regenerator condenser 50 is employed to recover a significant amount of the energy and water from the mixture, and the air-vapor mixture 48 would continue its flow path to enter the regenerator 50.

Similar to the case in FIG. 1, the regenerator 50 in FIG. 7 would be a counter-flow, direct-contact condenser with a packed bed or packing, wherein the colder water, designated by 56, exits packing 34 with a reduced temperature of t_{w2} and a lowered water mass flow rate of r_{wa2} and is pumped from a water tank 60 to a water distribution system 62 on top of the regenerator 50 through a peripheral water tank 64. The air-water mixture 48 enters the regenerator 50 from the bottom of the regenerator condenser with tₑ, Wₑ, and leaves the regenerator with a significantly reduced temperature, tᵣₑ, and vapor content, Wᵣₑ, as designated by 74. After passing through a drift eliminator 72, the air-vapor mixture or moist air flow stream 74 flows out of the regenerator 50 and enters a vacuum pump or compressor system 80. The pressure in the regenerator should be close to the turbine back pressure as the pressure drop through the regenerator is generally small. As discussed earlier in this disclosure, the back pressure, p_{b}, should be sufficiently lower than the ambient pressure to create a sufficient expansion ratio for the operation of the turbine. In this case, a vacuum pump system is needed to maintain the lower pressure at the outlet of the turbine while raising the pressure of the air-water mixture out of the regenerator 50 and discharging it to the ambient. The vacuum pump system 80 as shown in FIG. 7 is an axial compressor system, but it could be a centrifugal compressor system or another type of vacuum pump system. To reduce the power consumption of the compressor system, at least an intercooler may be employed.

Referring to the compressor system 80 in FIG. 7, the air-vapor mixture 74 at tᵣₑ and Wᵣₑ enters a first compressor 84 and is compressed to t_{c1o}. The air-vapor mixture then enters an intercooler 86 and its temperature is cooled down to t_{c2i}. Finally, the air-vapor mixture enters a second compressor 88 and is compressed to a pressure near ambient pressure pₐₘ to be discharged into the surroundings at a temperature t_{ed}. To prevent the power plant from being flooded in rainy or snowy seasons, a roofing structure 90 may be installed on top of the power plant.

It is well known in the art that the power consumption of the compressor system is not only sensitive to the inlet temperature of the air but also sensitive to moisture in the air. In this consideration, the mass flow rate of water 56 out of the packing and being pumped into the regenerator condenser may not be enough to reduce the vapor content of the exiting air-vapor mixture 74. Therefore, cooling water flow stream 100 with a temperature of t_{c} and a mass flow rate of r_{wac} may be added into regenerator condenser 50, wherein t_{c} would be preferably close to the ambient temperature. In addition to the benefit of reducing the vapor content of air-vapor mixture 74 at the inlet of the compressor system for power consumption reduction, the addition of the cooling water 100 would enable the power plant to provide hot water for various users, as an amount of hot water 104 may be extracted near or at the bottom of the regenerator for uses or being stored for future uses, as shown on the left side of the regenerator 50. In FIG. 7, flow stream 104 is seen being extracted at the bottom of the regenerator condenser 50, but the extraction could be at any suitable location of the regenerator. Also, regenerator 50 as shown in FIG. 7 is essentially the combination of a regenerator and a heat or water recovery unit.

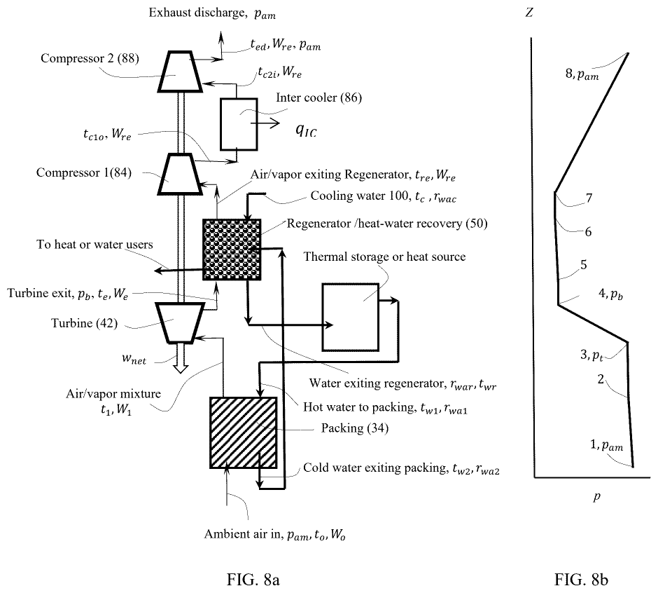

To enhance the understanding of the system shown in FIG. 7, a flow diagram demonstrating the operation principle of the power plant is shown in FIG. 8a, wherein q_{IC} is the heat removal from the intercooler of the vacuum-pump compressor system. The pressure distribution of the working fluid along with the height Z of the power plant is also schematically shown in FIG. 8b. Referring to FIG. 8b, the ambient air enters the packing at an ambient pressure pₐₘ (point 1). Air-vapor mixture exits the packing with a slight pressure drop (point 2) and then enters the turbine to produce power (point 3). The air-vapor mixture exits the turbine (point 4) with a turbine back pressure p_{b}. Then it enters a regenerator/heat-water recovery unit at point 5. With significantly reduced vapor content and temperature, the air-vapor mixture or moist air exits the regenerator at point 6 and enters the vacuum-pump compressor system at point 7. Finally, at point 8, the moist air has been compressed to the ambient pressure pₐₘ for discharging into the ambient.

Performance evaluation was undertaken for the power plant with a vacuum-pump compressor system as shown in FIGS. 7 and 8 at different hot water inlet temperatures of t_{w} and turbine backpressure p_{b}, and some typical results are shown in Table 4 (Cao, 2022b). For all the results in the table, the ambient temperature was set at tₒ=15° C., the isentropic efficiencies for the compressor and turbine system were, respectively, set at 90% and 95%, the power plant diameter was still set as D=6 m, the temperature of the cooling water 100, t_{c}, is 20° C., five degrees higher than the ambient temperature, the exiting temperature of the air-vapor mixture out of the regenerator is 22° C., two degrees higher than the cooling water inlet temperature, and both water outlet temperatures from the regenerator, respectively to the storage/heat source and the heat or water users, were set at two degrees lower than the inlet temperature of the air-vapor mixture 48 into the regenerator.

For some hot water temperatures lower than 100° C. under low turbine backpressure, the power consumption of the vacuum-pump compressor system is too high relative to the power output of the turbine due to excessive vapor content entering the compressor system. For this reason, the chiller cooling, similar to that for the frontal compressor system in FIG. 1, was used to cool the air-vapor mixture before entering the compressor system to 10° C. below the ambient temperature to significantly remove the vapor content in the mixture. Then the power output of the turbine and thermal efficiency were corrected based on the power consumption of the chiller.

TABLE 4
Some performance results for the power
plant with vacuum-pump compressors.

| | Turbine | | | | | Second- |
|---|---|---|---|---|---|---|
| | back | | wₙₑₜ | Power | Thermal | law |
| t_{w} | pressure | Chiller | (kJ/kg | capacity | efficiency | efficiency |
| (° C.) | (bar) | cooling? | dry air) | (MW) | (%) | (%) |
| 100 | 0.25 | no | 885.7 | 305.6 | 14.66 | 64.3 |
| 100 | 0.25 | yes | 969.3 | 334.4 | 16.1 | 70.6 |
| 95 | 0.25 | yes | 321.7 | 111.0 | 13.8 | 63.6 |
| 90 | 0.30 | yes | 144.9 | 50.0 | 11.8 | 57.0 |
| 85 | 0.4 | yes | 68.9 | 23.8 | 10.0 | 51.0 |

As can be seen from the results in Table 4, the performance of the air-water power plant employing a back vacuum-pump compressor system improved dramatically at low hot water temperatures equal to or lower than 100° C. Some best results in the Table show that the power capacity and second-law efficiency have reached more than 300 MW and 64%, respectively, matching the performance of some fossil-fuel-based power plants even without chiller cooling. The power capacity could be further increased by increasing the diameter D, as the maximum pressure difference across the plant is less than 1 bar. Although the results in the table are for a lower ambient temperature of 15° C., the power plant could also work at a much higher ambient temperature with limited penalties. This can be accomplished by using a chiller to cool the intake ambient air (not shown) and the flow streams through any part of the compressor system including the intercooler. Since the chiller cooling effects have been demonstrated earlier in this disclosure associated with the embodiment in FIGS. 1 and 4, the demonstration for the embodiment associated with FIGS. 7 and 8 will not be repeated.

As discussed above, a high vapor content in the air-vapor mixture out of the regenerator and entering the compressor system in FIG. 7 would significantly increase the power consumption of the compressor system. For this purpose, a desiccant system may be deployed to reduce the vapor content in the air-vapor mixture before the mixture is directed into the compressor system. Desiccant-assisted air conditioning systems are commercially established systems with large-scale applications, resulting in significant improvements in A/C efficiency. The use of a desiccant system can also significantly reduce compressor power consumption and increase the efficiency of the power system shown in FIG. 1 with or without chiller cooling. The use of the desiccant system can also significantly decrease the load of the chiller system if it is employed. Additionally, the desiccant system can be used to reduce the moisture level in the intake air shown in FIG. 1 when the humidity level of the ambient air is high. Also, desiccant systems may be used to remove moisture in the exhaust, such as that on top of FIG. 1, FIG. 4, or FIG. 7, before the exhaust is discharged into the ambient to significantly reduce the water losses along with the exhaust air streams.

The operations of the embodiments of this invention in FIGS. 1 and 4 and FIGS. 7-8 were characterized by low pressure and low temperature. The low-pressure operation would enable a large power plant size for higher power capacity. The low-temperature operation could permit the use of low-cost materials for compressors and turbines as well as the plant casing and may significantly remove the issues related to the heat losses from the power plant casing to the ambient.

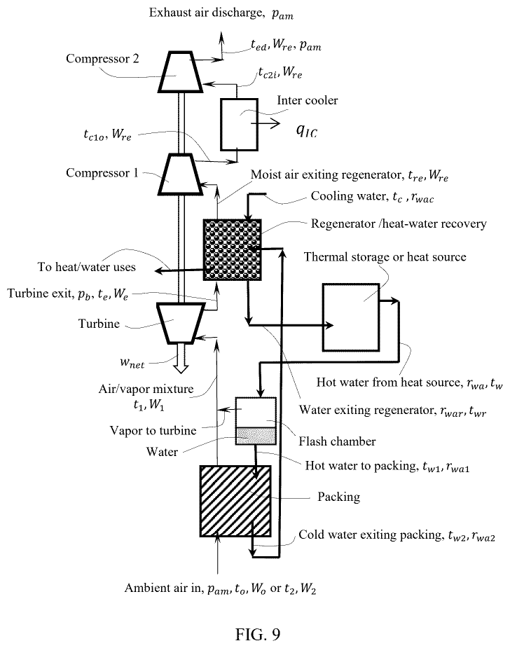

Referring to FIG. 7, for a higher hot water inlet temperature t_{w} greater than 100° C. with a pressure above ambient pressure, the hot water may be flashed through the water distribution system 54 before entering packing 34. The flashed vapor would join the air-vapor mixture to enter the turbine, which would further increase power production by the turbine. Alternatively, a separate flash chamber, as shown in FIG. 9, may be installed. The hot water would first enter the flash chamber with some of the water being flashed into vapor. The flashed vapor would join the air-vapor mixture to enter the turbine for work production, while the remaining water in the flash chamber enters the packing for the mass and heat transfer to the air entering the packing. The separate flash chamber shown in FIG. 9 may also be employed for other embodiments including that shown in FIG. 1. As shown in FIG. 9, the hot water from the heat source or storage system has a dimensionless flow rate of r_{wa}, which should be higher than r_{wa1} (the flow rate entering the packing) because of the flash operation.

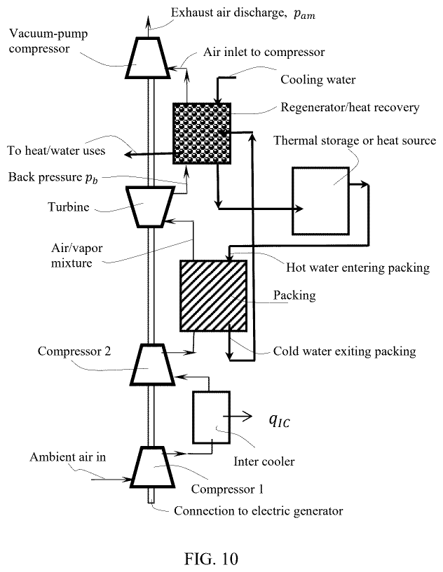

Thus far, two major embodiments of the air-water power plant of this invention have been disclosed, one with a frontal compression system (representatively shown in FIGS. 1-4) and the other with a back vacuum-pump compressor system after the turbine (FIGS. 7-8). The front compression to raise the pressure before the turbine and the back vacuum pump system to lower that pressure at the exit of the turbine may be combined as schematically shown in FIG. 10. The combination may accommodate a heat source temperature significantly higher than 100° C. while attaining the benefit of a lowered turbine backpressure through the vacuum-pump compression system for an increased turbine expansion ratio.

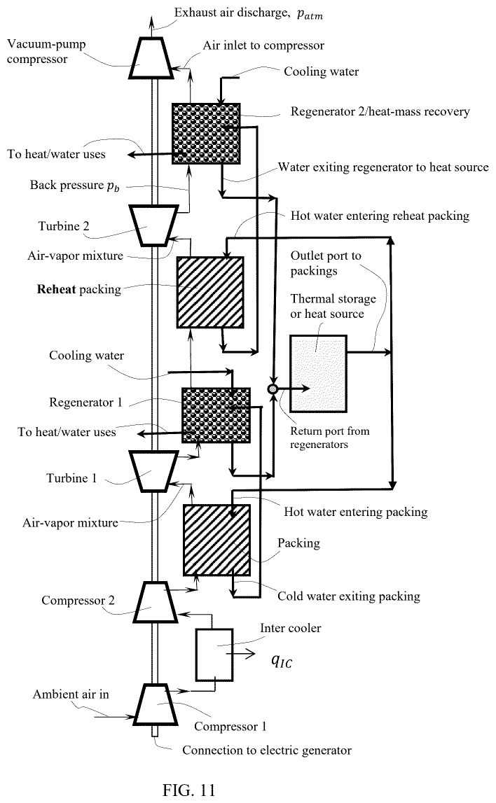

In addition to the regeneration and compressor inter-cooling, the reheat technique that was used in some conventional vapor power plants and gas-turbine power plants may also be adopted in this invention, as schematically illustrated in FIG. 11. Referring to FIG. 11, the frontal compressor system raises the pressure of the working fluid to sufficiently high pressure and two turbines (or two turbine stages) are employed to produce power. A reheat packing is added after the first turbine to provide energy to the working fluid before it enters the second turbine. The use of a vacuum pump compressor after the second turbine may significantly increase the expansion ratio of the second turbine. Regenerator 1 after turbine 1 may have the benefit of recovering significant energy content by the water exiting the first turbine and lowering the temperature and vapor content of the air-vapor mixture entering the reheat packing for higher thermal energy acquisition, which may increase the performance of the power plant. However, in some situations, regenerator 1 may be removed. The system shown in FIG. 11 includes a vacuum pump compressor to lower the turbine backpressure. However, the reheat mechanism may also be employed for air-water power plants without the vacuum-pump system such as the power plant embodiment shown in FIG. 1, although the employment is not shown herein.

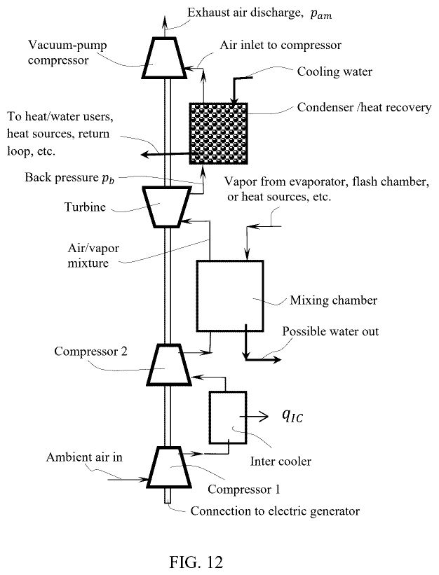

The packing, such as 34 shown in FIG. 1 or FIG. 7, is an essential component of the air-water power plant of this disclosure. However, under some circumstances, the packing may be removed. FIG. 12 shows an embodiment using a vapor as the energy-supply fluid. The vapor may be generated through an evaporator, geothermal underground reservoirs, a flash chamber such as that for a geothermal fluid, or a heat source such as a solar collector system, etc. but they are not shown in the figure. In this case, a mixing chamber is used to combine the flows of vapor and pressurized air. The air-vapor mixture exits the mixing chamber and enters the turbine to produce power. When the pressure of the vapor entering the mixing chamber is close to the ambient pressure, the compressor system before the mixing chamber may be removed. The embodiment of the power system in FIG. 12 essentially converts a conventional closed-cycle vapor power plant into an open-cycle system.

In this disclosure, performance demonstrations working at low heat-source temperatures are emphasized. However, the air-water power plant in principle may also work with high-temperature heat sources associated with, such as, but not limited to, concentrating solar receivers, deep geothermal wells, high-temperature industrial waste heat, fossil-fuel combustion, or nuclear reactions.

Chiller cooling is not just for hot summers when the ambient temperature is high for temperature and moisture reduction. Even at relatively low ambient temperatures, chiller cooling may still be used for performance improvement. Also, chiller cooling does not always mean reducing the flow temperature below the ambient temperature. At the inlet of the compressor system or in the intercooler, any more efficient cooling for the temperature reduction in those locations could attain possible performance improvement.

The temperature of the cooling water in the water or heat recovery unit, such as that depicted in FIG. 4, or the temperature of the cooling water 100 shown in FIG. 7, should ideally be close to the ambient temperature. To achieve this, water may be pumped from a water source designated for water treatment facilities or other freshwater uses. At the outlet of the recovery unit, higher-temperature water can be delivered to thermal energy-related users. If the hot water at the outlet is not needed, it may be returned to the original water source or stored in a water storage facility.

In the absence of thermal insulation, with a slower flow speed and smaller pipe diameter, the water may cool down without significant water-loss evaporation during its return to the original source. If the use of hot water is unnecessary, storage capacity is unavailable, or continuous supply from water sources to the power plant is not feasible, the water exiting the recovery unit may pass through a cooling system—either a wet cooling system like a cooling tower or a dry cooling system—to lower its temperature to near ambient levels before being recirculated back to the recovery unit. For water conservation, a dry cooling system is preferred, although it is not the subject of this disclosure.

In a post-fossil-fuel era, a significant portion of the heat for lower-temperature applications, such as industrial processes, domestic hot water, and home heating, may need to be supplied by electricity. In such cases, 1 kW of heat can be provided by 1 kW of electricity through an electric heater system. However, the same amount of heat can be provided by the lower-temperature water from the heat or water recovery unit of the air-water power plant described in this invention. This allows for almost complete utilization of the energy carried into the power plant by the heat-supply hot water from a heat source, either for power generation or heat uses, resulting in a combined power and heat energy utilization efficiency of possibly over 70%. Additionally, after passing through the combined regenerator and heat/water recovery unit, the water content in the exhaust stream can be significantly reduced, especially when chiller cooling is employed to further remove vapor content from the exhaust. Consequently, the net water loss from the power plant to the environment could be minimal.

It should be emphasized that while the air-water power plant described in this disclosure tends to be suited for large-scale power production, it is also applicable for medium or small-scale power production, including distributed power production and heat supply. For utility-scale power production, an axial turbine expander is preferred. However, other types of expanders, including but not limited to centrifugal, piston, scroll, screw, vane, roots, or trochoidal expanders, may be used in certain applications. Similarly, an axial compressor is preferred for utility-scale power production, but other types of compressor systems, such as centrifugal, ejector-pump, piston, scroll, screw, vane, roots, or trochoidal compressors, may be considered for smaller-scale power production, and other specific applications.

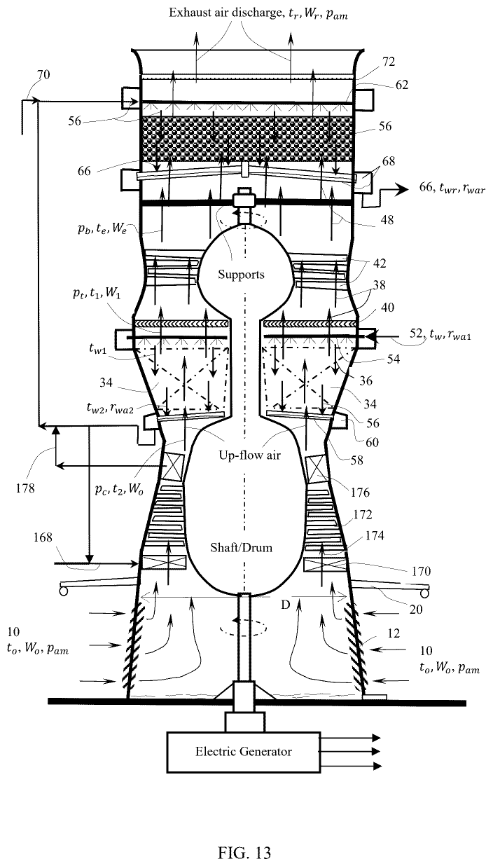

In FIG. 1 of this disclosure, it is crucial to maintain a low temperature of the compressed air at the compressor outlet or the inlet of the packing. While at least one intercooler may be used to achieve this, it could complicate the cooling system. To enhance compressor cooling and achieve a sufficiently low temperature at the inlet of the packing, the intercooler may be replaced with an internal cooling mechanism, such as internal water cooling as depicted in FIG. 13. In this approach, cooling water 168 is injected into the airflow using an injector 170, preferably before the air enters the compressor system 172, as shown in the lower portion of FIG. 13. This may be done in the form of water droplets or mist through mister nozzles or atomizing nozzles. The air/mist mixture 174 then enters the compressor 172 to be compressed. Due to the high thermal capacity of the water droplets, the heat generated during compression is largely absorbed by the water droplets. Consequently, the airflow can be maintained at a sufficiently low temperature at the compressor outlet. The water droplets in the air may be then removed through a water separator 176, as shown in FIG. 13, ensuring that the compressed air enters the packing without significant influence from the water droplets. The removed water can be cooled to near ambient temperature and recirculated back to the water injector inlet (not shown). Although the cooling water for the compressor system could form its own flow loop (not shown), the colder water from the packing could be used as the coolant for the compressor, as schematically shown on the left side of FIG. 13. In this case, the removed water from the water separator may be directed to the top of the regenerative condenser to recover water and heat from the expanded vapor-air mixture exiting the turbine when the removed water temperature is sufficiently low.

The internal cooling technique described above may also be applied to the power plant configurations shown in FIG. 7 and FIG. 8 of this disclosure, where the vacuum-pump compressor is positioned at the top of the power plant. In this scenario, the mist eliminator 72 and the intercooler 86 in FIG. 7 may be removed, and the intercooler coolant may be used as an internal cooling coolant for the compressor system 80 in the form of water mist. A water separator (not shown) at the outlet of the compressor system 80 may be used to remove the water in the air before the exhaust is discharged into the ambient. While the internal cooling mechanism has been described for an axial compressor, similar internal cooling can also be employed for non-axial compressors, such as piston compressors and centrifugal compressors, even though they are not explicitly shown in this disclosure.

The issue of the negative effects of high summer temperatures and humidity on power plant performance is further addressed herein. Higher ambient temperatures can lead to increased intake air temperatures, higher cooling water temperatures for the water/heat recovery unit and regenerator, and elevated cooling water temperatures for compressor cooling, all of which may degrade power plant performance. Although a chiller, as shown in FIG. 6, may be employed to address these challenges, it could decrease the efficiency and increase the costs of the power plant. If feasible, air-water power plants may be constructed near an ocean, river, lake, or water wells, which can provide water with a substantially lower temperature than the summer ambient air temperature, to mitigate the problem directly or indirectly.

The Earth itself is an ideal heat source or sink due to its ability to maintain a nearly constant temperature at a certain depth. If the aforementioned water resources are unavailable, underground water circulating through buried piping systems may be used. When the cooling capacity of underground water is limited, cold water stored at the bottom of the Utility-Scale Underground Hot Water Storage (USUHWS) under thermal stratification conditions (Cao, 2022a) may be utilized. Additionally, Utility-Scale Underground Cold-Water Storage (USUCWS) may be constructed to store underground cold water to manage peak summer air temperatures and humidity. Since USUCWS is only used for peak summer conditions, the storage capacity required would be much lower than that of USUHWS. Furthermore, due to its zero thermodynamic gauge pressure and low temperature, the construction costs could be significantly lower than those of USUHWS. Another approach is to extract water colder than the ambient air from underground at a given location for power production. After its use, the warm water from the power plant can be injected back underground at a different location.

The utilization of various cold-water resources mentioned above can significantly reduce reliance on chillers. One implementation for intake air cooling involves injecting cold water into the air stream, followed by a water separation process (not shown). The cold water can be used to cool the “cooling water from the water source” at the top of FIG. 4 to below ambient air temperature, thereby condensing the vapor more effectively in the water or heat recovery unit. If the heat or water from the recovery unit is not needed, the water from the recovery unit can be cooled using cold water and returned to the recovery unit as the “cooling water from the water source.” Similarly, in FIG. 7, cold water can be used to cool the cooling water 100 to below ambient air temperature, enhancing the vapor condensation efficiency in the regenerator 50. If the heat or water 104 from the regenerator 50 is not needed, the water 104 from the regenerator can be cooled using cold water and returned to the regenerator 50 as the cooling water 100. Additionally, the cold water can serve as the water for the mist injector shown near the bottom of FIG. 13. In both cases discussed in FIGS. 4 and 7, if the cooling capacity of the cold water is limited or if the water temperature from the recovery unit or regenerator is too high, the water may first be cooled by an air-cooling system (preferably a dry cooling system) down to a temperature near ambient air temperature. Then, cold water from various sources can be used to further cool it below ambient air temperature. One skilled in the art will recognize that there are numerous other specific implementations of using cold water to enhance the performance of air-water power plants that are not detailed herein.

To conclude the disclosure of the air-water power plant, several additional points are mentioned below, even though they may not be directly interconnected:

The disclosed air-water thermal power plant utilizes hot water as the energy source for power production, either from a storage system or directly from a heat source. While renewable heat sources such as solar energy, geothermal energy, biofuels, and hydrogen-fuel systems may be preferred for hot water production, other energy sources may also be used for heat source diversification. These may include industrial waste heat, agricultural waste, combustion heat, and heat from a nuclear reactor.

As previously indicated, the energy-supply fluid is preferably a compressed liquid for transportation and spray in the water distribution system. However, in some situations, the energy-supply fluid may also be a liquid-vapor two-phase mixture or a superheated vapor.

In certain cases, the exhaust stream temperature from the power plant unit, such as those involving a vacuum-pump compressor system as shown in FIGS. 7 and 8, may be relatively high. In such cases, an energy recovery system may be employed, although it is not depicted in this disclosure.

The operational cycle described in this disclosure is primarily an open cycle, and the working fluids are mainly air and water. However, the power plants disclosed in this invention can also operate in closed cycles and use working fluids other than air or water, or a combination of air with other fluids besides water, as well as a combination of water with gases other than air.

The term “air-vapor mixture” does not exclude the presence of liquid water in the mixture, particularly at the exit of the expander.

In some situations, a crossflow packing or regenerator could be used, although counter-flow arrangements are preferred.

The regenerator may also be configured as a heat exchanger where the water and the air-vapor mixture are separated by solid walls.

### Land Sharing of Solar Thermal Collector Systems

According to Cao (2022a), a substantial amount of hot-water storage will be required after the displacement of fossil fuels. If the energy for hot-water production comes from solar energy, the installation of solar thermal collectors for water heating may conflict with other land uses. As discussed earlier in this disclosure, commonly used solar thermal collectors are non-concentrating collectors, including evacuated tube collectors (ETCs) with heat pipe or U-tube configurations, evacuated flat plate solar collectors (EFPSCs), and combined ETC and compound parabolic collector (CPC) systems. These collector systems typically have simple structures with generally flat geometries, offering deployment flexibility and quicker startup times as they deal with water at lower temperatures.

To address potential land use challenges, land sharing may be considered as outlined below:
1. Dual-use Greenhouse Roofs: Solar thermal collector panels can serve as the roof of a greenhouse, with some space between individual evacuated tubes or between individual panels open to the greenhouse, allowing solar energy to enter through the openings while the collectors continue to generate hot water. The backside surface of the collector panels can dissipate heat into the greenhouse for winter warming. When necessary, the openings can be covered with glass or plastic film to further increase the greenhouse temperature in winter. These solar panels can also function as the roof of a house or solar house, with the backing of the evacuated tubes serving as roofing material or glass.
2. Flexible Deployment and Land Sharing: Since USUHWS can retain the thermal energy of hot water for years with minimal degradation, solar energy can be extracted and stored year-round, enabling land sharing or dual use. This means using land for power generation/heat supply as well as for agriculture, grass, or other non-hot water-related purposes. When solar energy availability is low, such as during cloudy, rainy, or snowy conditions, in the evening or early morning, or when hot water is not needed, the solar collectors can be folded, allowing solar beams to be used for other purposes. The folded position can also provide thermal insulation for the collector panels, enabling quick ramp-up when redeployed.
3. Temporary Land Use Prioritization: If land use has a higher priority than hot water production over an extended period, the solar collectors can be moved to a parking place, lowered to an underground position, or remain in place but folded vertically. Additionally, underground or above-ground pipelines can be installed to facilitate the water supply to the solar collectors and the hot water output from the solar collectors. The installed pipeline can also be used to provide cold water for irrigation and some of the hot water produced can be supplied to agricultural communities.

Finally, some techniques related to agrivoltaics can be used for the present solar thermal collector systems but are not elaborated herein.

The examples and embodiments described herein are for illustrative purposes only. Various modifications or changes in light of this disclosure will be apparent to persons skilled in the art and are intended to be included within the spirit and scope of this application. All patents and publications referred to or cited herein are incorporated by reference in their entirety, including all figures and tables, to the extent they are not inconsistent with the explicit teachings of this specification.

### REFERENCES CITED

Cao, Yiding (2022a). “An Ultimate Solution to Phasing out Fossil Fuels-Part I: Utility-Scale Underground Hot Water Storage (USUHWS) for Power Production and Heat Supply,” Frontiers in Heat and Mass Transfer (FHMT), 19-1, August 31, 2022.
https://www.researchgate.net/publication/363147927
Cao, Yiding (2022b). “An Ultimate Solution to Phasing out Fossil Fuels-Part II: Air-Water Thermal Power Plants,” Frontiers in Heat and Mass Transfer (FHMT), 19-2, August 31, 2022.
https://www.researchgate.net/publication/363281042
DAIKIN (2020). Technology Development to Improve Performance with R-123ze, Retrieved 2022-1-21.
https://www.daikinapplied.eu/news-center/the-advantages-of-r1234ze-refrigerant/
EERE-U.S. DOE Energy Efficiency and Renewable Energy, “Electricity Generation,” Retrieved 2022-1-21. https://www.energy.gov/eere/geothermal/electricity-generation#binarycycle
EESI-Environmental and Energy Study Institute (2019). Fact Sheet-Energy Storage.
https://www.eesi.org/papers/view/energy-storage-2019
Evans, P. (2017) Chiller Efficiency How to Calculate, Retrieved 2022-1-21.
https://theengineeringmindset.com/chiller-efficiency-calculate/
Hewitt, G.F., Shires, G.L., and Bott, T.R. (1994). Process Heat Transfer, Chapters 22 and 23, Begell House, Boca Raton.
Hill, G.B. Pring, E.J., and Osborn, P.D. (1990). Cooling Towers-Principles and Practices, Butterworth-Heinemann, London.
HVAC HESS, Chiller Efficiency, Retrieved 2022-1-21.
https://www.energy.gov.au/sites/default/files/hvac-factsheet-chiller-efficiency.pdf.
Moran, M.J., Shapiro, H.N., Boettner, D.D., and Bailey, M.B. (2011). Fundamentals of Engineering Thermodynamics, 7th Edition, Wiley.
McQuiston, F.C., Parker, J.D., and Spitler, J.D. (2005). Heating, Ventilating, and Air Conditioning—Analysis and Design, 6th Edition, Wiley.
Moss, R.W., Henshallb, P., Aryac, F., Shirea, G.S.F., Hydec, T., and Eames, P.C. (2018). “Performance and operational effectiveness of evacuated flat plate solar collectors compared with conventional thermal, PVT and PV panels,” Applied Energy, Vol. 216, pp. 588-601.
https://doi.org/10.1016/j.apenergy.2018.01.001

What is claimed is:

1. A power and thermal energy system comprising:
a thermal power plant and a thermal energy system, said power plant including:
at least one expander, at least one direct-contact heat and mass exchanger, an energy-supplying fluid, and an energy-receiving fluid,
wherein said thermal energy system undertakes at least one of the following two processes: delivering hot water to said power plant as a heat-supplying fluid from an energy storage system and delivering hot water as a heat-supplying fluid from a heat source, wherein said direct-contact heat and mass exchanger facilitates heat and mass transfer from said energy-supplying fluid to said energy-receiving fluid, and wherein said energy-receiving fluid expands in said expander to generate power.

2. The power and thermal energy system according to claim 1, wherein said hot water is in at least one of the following states: liquid, liquid-vapor two-phase mixture, and superheated vapor, and wherein said energy-receiving fluid is at least one of the following: air, vapor, air-vapor mixture, and air-vapor-liquid mixture.

3. The power and thermal energy system according to claim 1, wherein said power plant further includes at least a regenerator, and wherein heat and water associated with the energy-receiving fluid exiting said expander are recovered.

4. The power plant according to claim 1, wherein at least a compression system is installed at one of the following two positions: before a direct-contact heat and mass exchanger to increase the expansion ratio between the inlet and outlet of an expander, and between the exit of an expander and an exhaust port of the power plant to achieve at least one of the following two objectives: increasing the expansion ratio of the expander and discharging exhaust out of the power plant.

5. The power plant according to claim 1, wherein at least a compression system is installed and the compression system is cooled through an internal cooling mechanism using water as a coolant.

6. The power plant according to claim 4, wherein at least a chiller is employed to achieve at least one of the following: to reduce the temperature of the power plant intake heat-receiving fluid, to reduce the temperature of the energy-receiving fluid at the inlet of a compression system, and to reduce the temperature of the energy-receiving fluid at a position between the inlet and outlet of an installed compression system.

7. The power plant according to claim 1, wherein said energy-supply fluid is a vapor and said vapor enters an expander with air, and wherein the direct-contact heat and mass exchanger is removed.

8. The power plant according to claim 4, wherein at least one of the following water resources: underground water, river water, seawater, lake water, and well water, is employed to achieve at least one of the following: to reduce the temperature of the intake energy-receiving fluid, to reduce the temperature of the energy-receiving fluid at the inlet of an installed compression system, and to reduce the temperature of the energy-receiving fluid at a position between the inlet and outlet of an installed compression system.

9. The power plant according to claim 1, wherein the expander system includes at least two expanders and wherein a reheat heat and mass exchanger is added between the outlet of the first expander and the inlet of the second expander.

10. The power plant according to claim 1, wherein the energy-supply fluid is a liquid and some of the liquid is flashed into vapor before being admitted into a direct-contact heat and mass exchanger, and wherein flashed vapor bypasses said exchanger and enters said expander.

11. The power plant according to claim 3, wherein water is delivered to users from at least one of the following systems: a regenerator and a heat or water recovery unit.

12. The power plant according to claim 1, a desiccant system is employed to achieve at least one of the following: to reduce the moisture of power-plant intake air, to reduce the moisture of the air-vapor mixture at the inlet of a compression system, and to recover water from an exhaust stream before being discharged into the ambient.
